(19) United States
(12) Patent Application Publication
(10) Pub. No.: US 2009/0014981 A1
(43) Pub. Date: Jan. 15, 2009

(54) Segmented frame bicycle

(76) Inventor: E.J. Perry, Roseville, CA (US)

Correspondence Address: LAW OFFICES OF JOHN BARGERO, PO BOX 471857, SAN FRANCISCO, CA, 94123, US

(21) Appl. No.: 11/827,580

(22) Filed: Jul. 13, 2007

(51) Int. Cl. B62K 3/02

(52) U.S. Cl. 280/281.1

(57) ABSTRACT

The present invention discloses a novel or trick bicycle with a segmented horizontal frame cross member that has a joint located between the rider's seat post and the front forks of the bicycle situated, so that the forward section of the cross member may rotate in the same plane as the front wheel without interfering with the rider's legs or knees allowing for acrobatic riding maneuvers.

### BACKGROUND OF THE INVENTION

This invention relates to a novel bicycle, more specifically a bicycle designed for extreme sports and acrobatics. The bicycle has been around for a very long time and there has been continual improvements or enhancements to increase its performance or usability.

In this instance, a modification to the traditional bicycle frame has been made to increase the maneuverability of the bicycle. In particular, the upper cross member has been fitted with a pivoting joint akin to that of the steering fork to decrease the bicycle's turning radius and therefore its maneuverability.

Improving the steer-ability of bicycles has been attempted before with the most notable design being the Swing Bike™, but has failed to capture wide acceptance. One reason for this could be that in an effort to maximize maneuverability the articulating joint has been placed too close to the riders legs which creates two major problems. The first is that the displacement of the cross member is limited by how far the rider can spread his legs and secondly, as a corollary, radical rotation of the cross member can actually sweep the rider off the bicycle, a very undesirable effect.

### SUMMARY OF THE INVENTION

The present invention discloses a novel bicycle that combines the features of a traditional bicycle with improved steering capabilities while providing the maximum amount of safety and control for the rider. This is achieved by bifurcating the frame between the seat post and the steering fork tube and inserting a vertical axis pivot point at a point that will allow the two sections of the frame to rotate and not interfere with the rider's legs.

The term stunt bike, articulated frame bike, segmented frame bike, and segmented bike are interchangeable, but for the sake of clarity, the term segmented-bike will be used throughout.

### DETAILED DESCRIPTION OF THE DRAWINGS

FIG. 1 is a side view of the bicycle frame.

FIG. 2 is a top plan view of the bicycle frame with the frame joint centered.

FIG. 3 is analogous to FIG. 2 with frame joint rotated to the left of the rider.

FIG. 4 is a side view of the frame joint.

FIG. 5 is a side view of the frame joint depicting internal parts.

### DESCRIPTION OF THE DRAWINGS AND PREFERRED EMBODIMENTS

While describing the invention and its embodiments, various terms will be used for the sake of clarity. These terms are intended to not only include the recited embodiments, but also all equivalents that perform substantially the same function, in substantially the same manner to achieve the same result. Although, the term bicycle is used throughout this application can readily be applied to bicycle-like machines having more than two wheels.

A preferred embodiment of the present invention discloses a segmented bicycle shown in a side view in FIG. 1 and indicated generally by reference numeral 500, is comprised of all of the normal elements of a traditional bicycle such as a seat 1, pedals 10, a crank 20, front chain sprocket 30, rear chain sprocket 40, drive chain 50, rear wheel 60, front wheel 70, steering forks 80, handlebars 90, brakes 95, with the addition of forward frame section 100, a rear frame section 110, a frame joint assembly 120 and a frame joint stop 130. These items are in standard bicycle configuration, that is the rear wheel is attached to the frame in the rear, the rear sprocket is mounted to the rear wheel, the cranks are located forward of the rear wheel and so on.

The frame joint assembly 120 connects and is situated between the rear frame section 110 and the forward frame section 100 allowing the forward frame section to rotate either to the right or to the left of the rider with an axis parallel to the steering fork. Theoretically, the forward frame section 100 could rotate almost 180 degrees off center, but due to interference issues and ride-ability it has been determined that limiting this rotation to approximately 90 degrees from center with frame joint stops 130 is optimal.

It has been contemplated in alternative embodiments, shown in FIG. 5, that there be a centering spring 140 located inside of the frame joint assembly 120 to provide some resistance to the rotation of the forward frame section 100 to aid in the control of the bike. The spring has the additional function of centering the joint or to return the forward frame section 100 so that it is line with the rear frame section 110 when the maneuver is completed. This spring could be of various tensions or event adjustable to accommodate different types of riders as well as different riding conditions.

Furthermore, it has been contemplated to install a locking mechanism 150 in the frame joint 120 to prevent the forward frame section 100 from rotating relative to the rear frame section 110 so that the bike may be ridden as a traditional fixed framed bike, which is shown in FIG. 4 as a simple pin through the frame joint assembly 120, but various other locking configurations are possible.

FIG. 5 depicts one embodiment of the frame joint assembly 120 displaying its internal parts, an upper bearing 160, a lower bearing 170, a external housing tube 180, an internal bearing shaft 190, and an optional centering spring 140. The external housing tube 180 is a piece of pipe of sufficient internal diameter and length to accommodate the upper and lower bearings 160, 170 and internal bearing shaft 190. Furthermore, a portion of one of the sidewalls of the external housing tube 180 is removed so that sufficient material is removed to allow the forward frame section 100 to rotate freely within the tube 180, but also allow enough material at the top and bottom of the tube 180 to secure and support the bearings 160, 170. The easiest way to accomplish this is to run an end mill perpendicular to the central axis of a piece of pipe, so that the cross sections of the upper and lower portions are circles, while the central section has a semi-circle cross section.

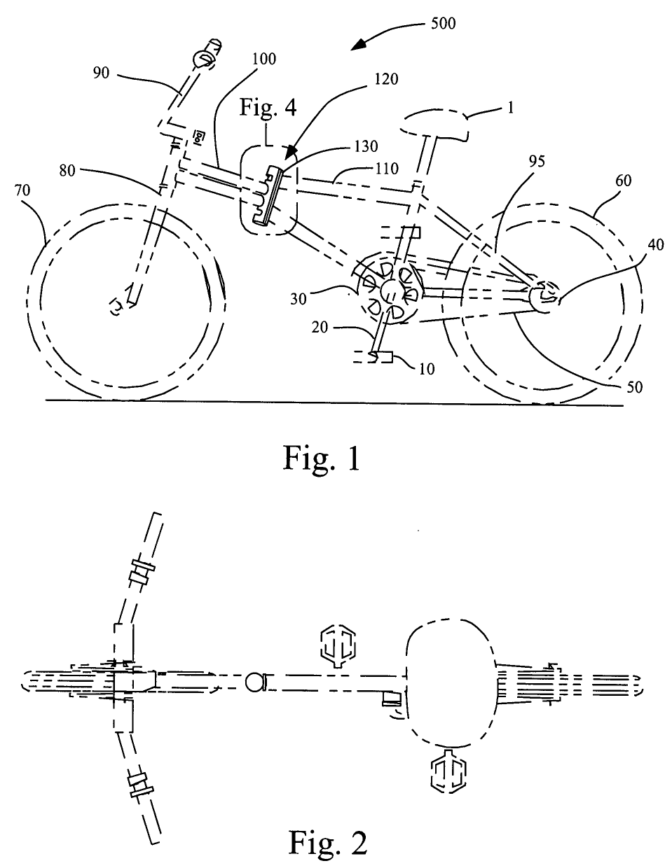

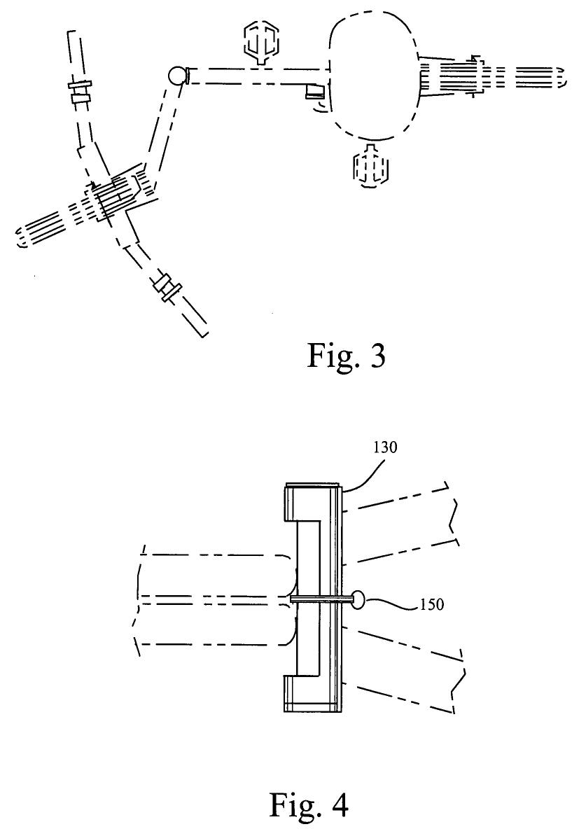

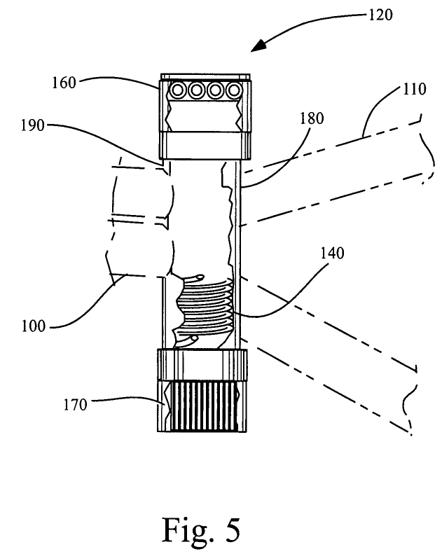

The depicted embodiment describes a combination of a thrust bearing and a roller bearing, but two thrust bearings have also been contemplated. The internal bearing shaft 190 is affixed to the forward frame section 100 while the rear frame section 110 is affixed to the external tube housing 180 allowing the two frame sections to rotate around the bearing shaft.

Although the figures depict the forward and rear frame sections 100 and 110 each comprise two sections of tubing, it is contemplated in alternative embodiments that the number can decrease or increase without any deviation from the inventor's intent. It will be evident that various further modifications are possible without departing from the scope of the invention as set forth in the following claims.

What is claimed is:

1. A bicycle with a segmented frame which enables a rider to engage in trick and novelty riding comprising; a steerable front wheel and fork assembly wherein said fork is affixed to a handlebar, a seat, pedals, a crank, front chain sprocket, rear chain sprocket, drive chain, rear wheel, forward frame section, rear frame section and a frame joint assembly assembled in a standard bicycle configuration, wherein said forward frame section terminates at said handlebar at one end and is affixed to said frame joint assembly at the other end with said frame joint assembly located aft of the seat affixed to said rear frame section at one end and terminates at said seat allowing the front portion of the segmented frame to rotate on the same plane as the front forks located at a distance to avoid contact with the rider's knees while making maneuvers.

2. The bicycle of claim 1 wherein the frame joint assembly contains at least one centering spring member to return the segmented frame to centered position.

3. The bicycle of claim 1 wherein the frame joint assembly further comprises a locking device to prevent rotation of frame joint.

4. The bicycle of claim 1 wherein said frame joint assembly has stops to limit the rotation of the joint in at least one direction.

5. The bicycle of claim 1 wherein said frame joint assembly comprises; an internal bearing shaft affixed to a forward frame member, an external tube housing affixed to a rear frame member, at least one thrust bearing, whereby said thrust bearing surrounds and encompasses said internal bearing shaft which is then surrounded and encompassed by said external tube housing allowing said internal shaft to rotate within said tube housing, with said tube housing having a sufficient portion of its exterior wall removed to allow said forward frame member to rotate relative to said rear frame member.

6. A frame joint assembly comprising; an internal bearing shaft affixed to a forward frame member, an external tube housing affixed to a rear frame member, at least one thrust bearing, whereby said thrust bearing surrounds and encompasses said internal bearing shaft which is then surrounded and encompassed by said external tube housing allowing said internal shaft to rotate within said tube housing, with said tube housing having a sufficient portion of its exterior wall removed to allow said forward frame member to rotate relative to said rear frame member.

7. The frame joint assembly of claim 6 wherein the frame joint assembly contains at least one centering spring member to return the segmented frame to centered position.

8. The frame joint assembly of claim 6 wherein said frame joint assembly further comprises a locking device to prevent rotation of frame joint.

9. The frame joint of claim 6 wherein said frame joint assembly has stops to limit the rotation of the joint in at least one direction.
